(19) United States
(12) Patent Application Publication
(10) Pub. No.: US 2008/0121498 A1
(43) Pub. Date: May 29, 2008

(54) ACCUMULATION-AND-RELEASE ROLLER-BELT CONVEYOR

(75) Inventors: Mark Costanzo, River Ridge, LA (US); Joseph M. DePaso, River Ridge, LA (US); Timothy C. UnKauf, Bowersville, GA (US)

Correspondence Address: LAITRAM, L.L.C.;LEGAL DEPARTMENT, 220 LAITRAM LANE, HARAHAN, LA, 70123, US

(73) Assignee: LAITRAM, L.L.C., Harahan, LA (US)

(21) Appl. No.: 11/564,487

(22) Filed: Nov. 29, 2006

(51) Int. Cl. B65G 17/24; B65G 47/26

(52) U.S. Cl. 198/779; 198/459.6

(57) ABSTRACT

An accumulation-and-release conveyor using a roller belt with rollers arranged to rotate in the direction of belt travel. The rollers extend through the thickness of the belt to support conveyed articles. The belt continuously advances along a conveyor carryway from an upstream end to a downstream end. A movable stop divides the carryway into an upstream article-accumulation zone and a downstream article-acceleration zone. In the accumulation zone, the rollers are freely rotatable; in the acceleration zone, the rollers roll on a bearing surface underlying the belt. The stop is selectively moved between a blocking position preventing articles from passing and accumulating them with low back line pressure on the freely rotatable rollers in the upstream accumulation zone and a release position allowing articles to pass to the accumulation zone where they are propelled forward and separated from each other by the rotation of the rollers rolling on the bearing surface.

### BACKGROUND

The invention relates generally to power-driven conveyors and, more particularly, to conveyors using conveyor belts with article-supporting rollers rotatable in the direction of belt travel to accumulate and selectively release accumulated articles.

Conveyors are used in industrial applications to transport articles from one processing station to another. Often a continuously moving conveyor belt is used to deliver articles to a downstream processing station. As soon as the supply of articles exceeds the handling capacity of the downstream processing station, the articles begin to back up at a stopping mechanism blocking the conveyor at a position upstream of the processing station. Friction between the conveying surface of the moving belt and the backed-up, or accumulated, articles causes the articles to push against each other. The pressure exerted against the article at the front of the group of accumulated articles is called back line pressure. As more articles back up, the back line pressure increases. Back line pressure can cause damage to the articles, excessively load the conveyor belt and its drive components, and accelerate belt wear. Zone accumulation, in which a series of separately driven conveyors can be stopped and started depending on the downstream demand and upstream supply of articles, is used to eliminate back line pressure. But zone accumulation requires multiple drives and sensors, which can be costly, and, between consecutive conveying zones, transfers, at which articles are susceptible to tipping. Roller-top belts with freely rotatable rollers in rolling contact with the undersides of conveyed articles are often used to reduce friction and lower back line pressure. The roller-top belts are typically followed by an indexing conveyor with a high-friction conveying surface that stops to serve as a stop mechanism and allow upstream articles to accumulate with low back line pressure atop the rollers of the roller-top belt and starts to release articles for delivery downstream. Like zone accumulation, this arrangement requires separately driven conveyors and suffers from some of the other shortcomings.

Thus, there is a need for a conveyor that can accumulate and release conveyed articles without the shortcomings of zone accumulators and separate accumulation and indexing conveyors.

### SUMMARY

These shortcomings are overcome by an accumulation-and-release conveyor embodying features of the invention. According to one aspect of the invention, a conveyor comprises a conveyor belt advancing in a direction of belt travel from an upstream end to a downstream end. The conveyor belt includes rollers that extend through the thickness of the conveyor belt and that can rotate in the direction of belt travel. A movable stop is positioned along the conveyor belt between the upstream end and the downstream end. The stop moves between a blocking position blocking conveyed articles and a release position allowing articles to pass. A bearing surface disposed below the conveyor belt downstream of the movable stop contacts the rollers from below and causes them to rotate by frictional rolling contact with the bearing surface as the conveyor belt advances. The rollers in the conveyor belt upstream of the movable stop are freely rotatable without frictional contact below the conveyor belt to allow blocked articles to accumulate with low back line pressure.

In another aspect of the invention, a conveyor comprises a carryway extending in length from an upstream end to a downstream end supporting a conveyor belt advancing in a direction of belt travel along the length of the carryway. The conveyor belt has an outer article-conveying surface and an opposite inner surface. Salient portions of rollers rotatable in the direction of belt travel extend past the outer and inner surfaces of the conveyor belt. A bearing surface underlying the conveyor belt contacts the salient portions of the rollers extending past the inner surface of the conveyor belt in a downstream portion of the carryway. The downstream portion defines an article-acceleration zone in which the contact between the rollers and the bearing surface as the belt advances in the direction of belt travel causes the rollers to rotate with the salient portions of the rollers extending past the outer surface of the conveyor belt rotating in the direction of belt travel. A movable stop disposed upstream of the article-acceleration zone separates the article-acceleration zone from an upstream article-accumulation zone in which the salient portions of the rollers extending past the inner surface of the conveyor belt are free of contact. The movable stop moves between an accumulation position and release position. In the blocking position, the stop blocks articles in the article-accumulation zone from advancing to the article-acceleration zone and allows the blocked articles to accumulate with low back line pressure atop the rollers in the article-accumulation zone. In the release position, the stop moves aside to allow articles to advance downstream with the conveyor belt into the article-acceleration zone to be accelerated in the direction of belt travel atop the rotating rollers rolling on the bearing surface.

In yet another aspect of the invention, a method for conveying objects comprises: (a) advancing a conveyor belt having article-supporting rollers extending through the thickness of the conveyor belt in a direction of belt travel along a conveyor; (b) rotating the rollers in a downstream portion of the conveyor in the direction of belt travel to propel articles atop the roller in the direction of belt travel at a speed greater than the speed of the belt; (c) supporting the conveyor belt in an upstream portion of the conveyor without contacting the rollers; and (d) selectively blocking and releasing articles conveyed on the conveyor belt at a position along the conveyor between the upstream portion and the downstream portion.

### BRIEF DESCRIPTION OF THE DRAWINGS

FIG. 1 is a top plan view of an accumulation-and-release conveyor embodying features of the invention;

FIGS. 2A-2C are side elevation views of the conveyor of FIG. 1, showing its sequence of operation;

FIGS. 3A and 3B are a side elevation view and a larger-scale top plan view of another version of an accumulation-and-release conveyor embodying features of the invention, including a pair of parallel roller belts; and

FIG. 4 is a top plane view of a multi-lane accumulation-and-release conveyor as in FIG. 1.

### DETAILED DESCRIPTION

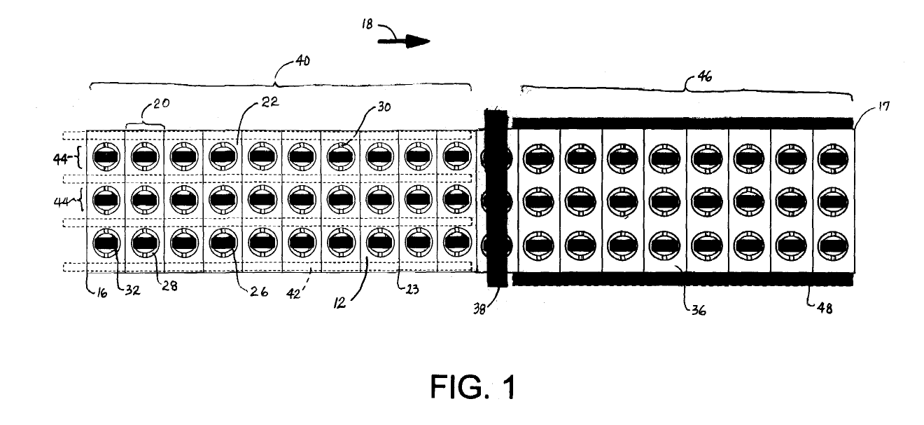

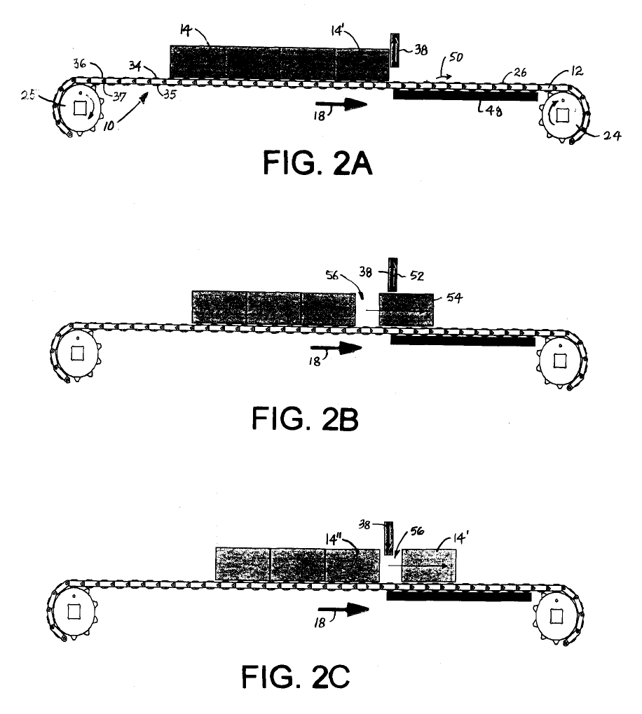

One version of a conveyor embodying features of the invention is shown in FIGS. 1 and 2A. The figures depict an upper carryway portion 10 of a belt conveyor using a conveyor belt 12 to convey articles 14 along the carryway from an upstream end 16 to a downstream end 17 in a direction of belt travel 18. The preferred conveyor belt is a modular plastic conveyor belt constructed of rows 20 of belt modules 22 connected together at hinge joints 23 that allow the belt to articulate about drive 24 and idle 25 sprockets at the downstream and upstream ends of the carryway. Rollers 26 are retained in cavities 28 formed in the belt by axles 30 spanning the cavities. The axles, which extend through bores in the rollers, are oriented in the width direction of the conveyor belt—perpendicular to the direction of belt travel. This allows the rollers to rotate in the direction of belt travel about the axes of the axles. The rollers shown are generally spherical in shape with a raised tread 32 along the equator defining the diameter of the roller. The periphery of the tread may be coated with or formed by an elastomeric or rubber-like material to provide a high-friction characteristic for a better grip. The diameter of the rollers exceeds the thickness of the conveyor belt so that salient portions 34, 35 of the rollers extend past the outer conveying surface 36 and the opposite inner surface 37 of the belt.

The carryway is divided into two zones by a movable stop 38. In an upstream zone 40, the belt is supported atop parallel support rails 42 contacting the inner surface of the belt between longitudinal columns 44 of rollers. (The support rails are omitted from FIG. 2A for clarity.) In this upstream zone, the rollers, out of contact with carryway structure, are free to rotate on their axles. In a downstream zone 46, the rollers ride on a bearing surface 48 underlying the belt. As the belt advances the direction of belt travel, the salient portions of the rollers extending past the inner belt surface frictionally contact the bearing surface. The frictional contact causes the rollers to rotate on their axes with the salient portions of the rollers extending past the outer article-conveying surface of the belt rotating as indicated by arrow 50 in the direction of belt travel. An article supported atop the rotating rollers in the downstream zone is propelled along the carryway in the direction of belt travel at an absolute speed of twice the speed of the belt, or at a speed, relative to the outer conveying surface, equal to the belt speed, if there is no slip between the rollers and the bearing surface and between the rollers and the conveyed article.

The operation of the conveyor and the selectively movable stop is illustrated in the sequence of FIGS. 2A-2C. In FIG. 2A, the stop 38 is shown in a blocking position preventing articles 14 from passing to the downstream zone. The articles back up upstream of the leading article 14′. The freely rotatable rollers in the upstream, or article-accumulating, zone rotate in low-friction rolling contact with the blocked articles to reduce back line pressure on the accumulated articles. As shown in FIG. 2B, the stop moves upward 52 from the blocking position to a released position to allow the leading article 14′ to pass. The back line pressure, even though low, is enough to urge the accumulated articles forward. Once the leading edge 54 of the lead article reaches the downstream, or article-acceleration zone, the rotating rollers accelerate the article forward, separating it from the trailing articles and leaving a space 56 between the leading article and the trailing articles. The stop can be moved back to the blocking position through the space before the next accumulated article 14″ reaches the article-acceleration zone. Of course, the stop may remain in the released position to allow as many articles as required to pass before returning to the blocking position. The stop may be raised and lowered vertically, as shown, or may be moved laterally between the blocking position and the release position, as another example. In this way, a single conveyor belt continuously driven in the direction of belt travel, without stopping or starting, is used to provide an acceleration-and-release conveyor.

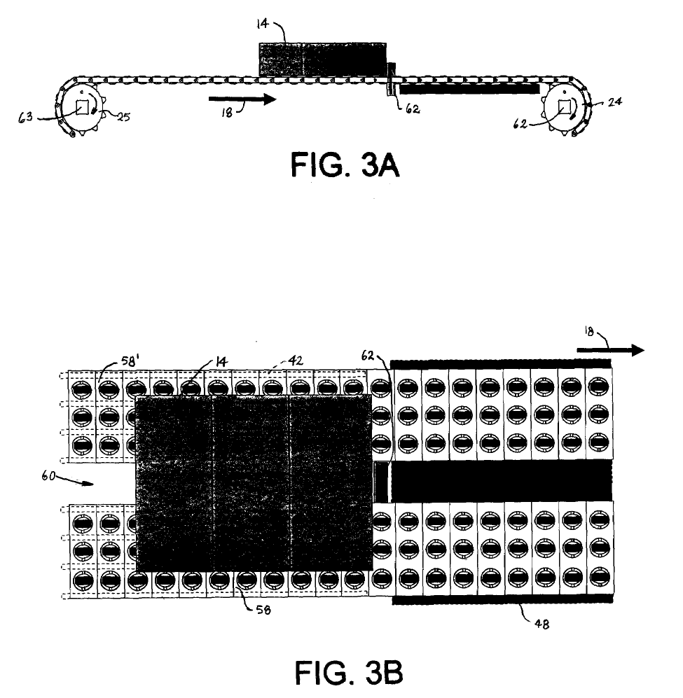

Another version of an accumulation-and-release conveyor is shown in FIGS. 3A and 3B. This conveyor uses a pair of parallel roller belts 58, 58′ separated across an intervening gap 60. Both belts advance in the direction of belt travel 18 at the same speed and may be mounted on sprocket sets 24, 25 on common drive and idle shafts 62, 63. Articles 14 conveyed atop the rollers span the gap with a portion supported on each belt. The gap between the conveyors allows a movable stop 62 to be lowered through the gap from a raised blocking position to a release position below the inner surfaces of the belts. This is preferable to a release position above the belt if overhead space is limited. In all other respects, the conveyor of FIGS. 3A and 3B operates the same as the conveyor of FIGS. 1 and 2 in accumulating articles upstream of the stop in an article-accumulation zone and in releasing articles to a downstream article-acceleration zone in which the belt rollers roll on an underlying bearing surface 48 as the belts advance together continuously in the direction of belt travel.

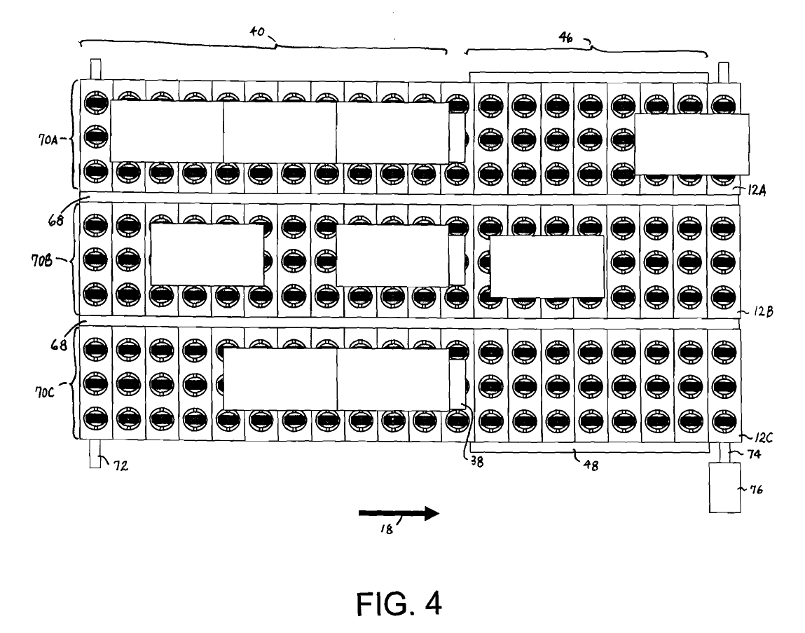

FIG. 4 depicts a three-lane accumulation-and-release conveyor similar to the single-lane conveyor of FIG. 1. The conveyor is constructed of three conveyor belts 12A, 12B, and 12C arranged side by side in parallel. The belts are separated by dividers 68 so that each belt forms an individual article-conveying lane 70A, 70B, 70C extending from the upstream end to the downstream end. Like the conveyor of FIG. 1, this multi-lane conveyor has an upstream accumulation zone 40 and a downstream article-acceleration zone 46 underlain by a bearing surface 48 on which the belt rollers 32 roll. Independently movable stops 38 are interposed between the two zones in each lane. All three belts are trained between drive and idle sprockets or drums mounted on common idle 72 and drive shafts 74 at opposite ends of the conveyor. A single drive motor 76 coupled to the common drive shaft is used to drive all three belts at the same speed in the direction of belt travel 18. Alternatively, the three parallel belts of FIG. 4 may be replaced by a single wide belt divided into three parallel lanes by dividers 68 positioned just above the belt's article-conveying surface.

The stops, whether the obstruction 62 of FIG. 3 or the gate 38 of FIG. 2, may be operated pneumatically, hydraulically, mechanically, or electrically in any conventional way. They may be controlled manually, by a simple timer, or by a controller receiving inputs from a variety of article sensors positioned along the conveying line.

Although the invention has been described in detail with respect to a few preferred versions, other versions are possible. For example, the belt may instead be a flat belt or a metal belt. The roller bearing surface, depicted as a flat bed, may be a series of parallel bearing surfaces, each underlying a column of rollers in the article-acceleration zone. The rollers may be integrally formed with axles or axle stubs whose opposite ends are received rotatably in openings in the interior of the body of the belt. So, as these few examples suggest, the scope of the claims is not meant to be limited to the preferred versions.

What is claimed is:

1. A conveyor comprising:
a conveyor belt advancing in a direction of belt travel from an upstream end to a downstream end, wherein the conveyor belt includes a plurality of rollers extending through the thickness of the conveyor belt and rotatable in the direction of belt travel;
a movable stop positioned along the conveyor belt between the upstream and downstream ends and movable between a blocking position blocking conveyed articles and a release position allowing articles to pass;
a bearing surface disposed below the conveyor belt downstream of the movable stop and contacting the rollers from below to cause the rollers to rotate by frictional rolling contact with the bearing surface as the conveyor belt advances; and
wherein the rollers in the conveyor belt upstream of the movable stop are freely rotatable without frictional contact below the conveyor belt.

2. A conveyor as in claim 1 further comprising a second like conveyor belt wherein both conveyor belts advance from the upstream end to the downstream end in the direction of belt travel in parallel across an intervening gap and are operated similarly to simultaneously convey an article spanning the gap.

3. A conveyor as in claim 2 wherein the movable stop moves through the gap.

4. A conveyor as in claim 1 wherein the movable stop moves vertically between the release position and the blocking position.

5. A conveyor as in claim 1 wherein the conveyor belt further includes axles retained in the belt perpendicular to the direction of belt travel and wherein the rollers are rotatable on the axles.

6. A conveyor as in claim 1 wherein the rollers on the conveyor belt are arranged in columns and further comprising belt support rails underlying the conveyor belt upstream of the movable stop in supporting contact with the conveyor belt between the columns of rollers.

7. A conveyor as in claim 1 further comprising:
one or more lane dividers disposed above the conveyor belt to divide the conveyor belt into parallel lanes extending in the direction of belt travel from the upstream end to the downstream end; and
one or more additional movable stops, disposed one stop per lane.

8. A conveyor as in claim 1 further comprising:
one or more conveyor belts as in claim 1 arranged in parallel to form parallel article-conveying lanes;
a movable stop for each article-conveying lane;
a common drive for all the conveyor belts to advance the conveyor belts in the direction of belt travel in parallel.

9. A conveyor comprising:
a carryway extending in length from an upstream end to a downstream end;
a conveyor belt having an outer article-conveying surface and an opposite inner surface supported in the carryway and advancing in a direction of belt travel along the length of the carryway from the upstream end to the downstream end, wherein the conveyor belt includes a plurality of rollers rotatable in the direction of belt travel with salient portions of the rollers extending past the outer and inner surfaces;
a bearing surface underlying the conveyor belt and contacting the salient portions of the rollers extending past the inner surface of the conveyor belt in a downstream portion of the carryway, the downstream portion defining an article-acceleration zone wherein the contact between the rollers and the bearing surface as the belt advances in the direction of belt travel causes the rollers to rotate with the salient portions of the rollers extending past the outer surface of the conveyor belt rotating in the direction of belt travel;
a movable stop disposed upstream of the article-acceleration zone and separating the article-acceleration zone from an upstream article-accumulation zone wherein the salient portions of the rollers extending past the inner surface of the conveyor belt are free of contact in the article-accumulation zone;
wherein the movable stop is movable between an accumulation position blocking articles in the article-accumulation zone from advancing to the article-acceleration zone and allowing the blocked articles to accumulate with low back line pressure atop the rollers in the article-accumulation zone and a release position allowing articles to advance downstream with the conveyor belt into the article-acceleration zone to be accelerated in the direction of belt travel atop the rotating rollers rolling on the bearing surface.

10. A conveyor as in claim 9 further comprising a second like conveyor belt supported in the carryway wherein both conveyor belts advance from the upstream end to the downstream end in the direction of belt travel in parallel across an intervening gap and are operated similarly to simultaneously convey an article spanning the gap.

11. A conveyor as in claim 10 wherein the movable stop moves through the gap.

12. A conveyor as in claim 9 wherein the movable stop moves vertically between the release position and the blocking position.

13. A conveyor as in claim 9 wherein the conveyor belt further includes axles retained in the belt perpendicular to the direction of belt travel and wherein the rollers are rotatable on the axles.

14. A conveyor as in claim 9 wherein the rollers on the conveyor belt are arranged in columns along the length of the conveyor belt and further comprising belt support rails underlying the conveyor belt in the article-accumulation zone in supporting contact with the inner surface of the conveyor belt between the columns of rollers.

15. A conveyor as in claim 9 further comprising:
one or more lane dividers disposed along the outer article-conveying surface of the conveyor belt to divide the article-conveying surface into parallel lanes extending in the direction of belt travel from the upstream end to the downstream end; and
one or more additional movable stops, disposed one stop per lane.

16. A conveyor as in claim 9 comprising:
one or more conveyor belts as in claim 9 arranged in parallel to form parallel article-conveying lanes;
a movable stop for each article-conveying lane;
a common drive for all the conveyor belts to advance the conveyor belts in the direction of belt travel in parallel.

17. A method for conveying articles on a conveyor, comprising:
advancing a conveyor belt having article-supporting rollers extending through the thickness of the conveyor belt in a direction of belt travel along a conveyor;
rotating the rollers in a downstream portion of the conveyor in the direction of belt travel to propel articles atop the roller in the direction of belt travel at a speed greater than the speed of the belt;
supporting the conveyor belt in an upstream portion of the conveyor without contacting the rollers;
selectively blocking and releasing articles conveyed on the conveyor belt at a position along the conveyor between the upstream portion and the downstream portion.
